(19) United States
(12) Patent Application Publication
(10) Pub. No.: US 2014/0288719 A1
(43) Pub. Date: Sep. 25, 2014

(54) POWER ELECTRONICS DEVICE, POWER CONNECTION INSPECTION METHOD AND NON-TRANSITORY COMPUTER READABLE MEDIUM

(71) Applicant: KABUSHIKI KAISHA TOSHIBA, Tokyo (JP)

(72) Inventors: Fumiaki Kanayama, Kawasaki-Shi (JP); Yasuyuki Nishibayashi, Kawasaki-Shi (JP); Keiichi Teramoto, Tokyo (JP); Yuki Yonezawa, Kawasaki-Shi (JP); Kotaro Ise, Kawasaki-Shi (JP); Ikuya Aoyama, Yokohama-Shi (JP)

(73) Assignee: KABUSHIKI KAISHA TOSHIBA, Tokyo (JP)

(21) Appl. No.: 14/199,046

(22) Filed: Mar. 6, 2014

(30) Foreign Application Priority Data
Mar. 19, 2013 (JP) 2013-056994

(51) Int. Cl. G05B 15/02

(52) U.S. Cl. CPC G05B 15/02
USPC 700/286

(57) ABSTRACT

According to one embodiment, there is provided a power electronics device including: a connection unit connected to a first power line; a communication unit; at least one unit of an electricity change unit and an electricity detection unit; and a control unit. The communication unit performs communication with other power electronics devices. The electricity change unit changes an energization state of the first power line and the electricity detection unit detects a change in the energization state of the first power line. The control unit specifies a power electronics device connected to the first power line out of the other power electronics devices using the communication unit and said at least one unit of the electricity change unit and the electricity detection unit.

### CROSS REFERENCE TO RELATED APPLICATIONS

This application is based upon and claims the benefit of priority from the prior Japanese Patent Application No. 2013-056994 filed on Mar. 19, 2013, the entire contents of which are incorporated herein by reference.

### FIELD

Embodiments described herein relates to a power electronics device, a power connection inspection method and a program.

### BACKGROUND

Take a moment to assume a system in which power electronics devices are provided with a communication function and autonomous cooperative control is applied between the power electronics devices to provide the flexibility of installation locations for the power electronics devices while enabling a fully-automatic capacity increase at the time of expansion and maintenance of a power electronics device.

At this time, for example, in a case where multiple power electronics devices are activated in parallel to increase an output of power, it is necessary to consider a function of phase synchronization of output power. An object of the phase synchronization of output power is to prevent an occurrence of cross current (e.g. reactive current caused by a difference of electromotive force, synchronization cross current caused by a phase difference of electromotive force and harmonic cross current caused by a waveform difference of electromotive force) in an output on the alternating-current side. First, it is essential to understand what characteristic the power electronics devices have, how many power electronics devices are connected and how the power electronics devices are connected via a power line.

In the related art, there is known a method of operating multiple power electronics devices in parallel by optical communication and implementing phase synchronization of output power without using a current-limiting reactor.

Moreover, there is known a method related to a wiring system in which a parent device performs communication and feeding with child devices by the use of power line communication and the parent device understands the connection number of child devices by the communication. However, the configuration is limited to a configuration with one parent device and multiple child devices, and, moreover, a wire is assumed to be provided in advance. A case is not assumed where the number of child devices is changed after operation is started, and the individual recognition of connected child devices is not performed. Moreover, although the power line communication is used for communication, there is a case where it is difficult to separate noise and communication signals in the power line communication depending on the use case.

Moreover, although there is disclosed a method where a device connects to one power router by the Plug and Play, cooperation with multiple power routers is not assumed and a wire is fixedly provided.

Thus, under a limited connection condition that a parent device and child devices are connected to a power line wired in advance, there are known a method of automatically acquiring power line connection information of multiple power electronics devices and a method of Plug and Play using a single power electronics device. However, there is not disclosed a method of automatically acquiring power connection Information in power electronics devices in which the number of components or the connection location is changed even after the start of operation without depending on preliminary wiring.

As described above, in the related art, there is a problem that it is not possible to automatically acquire information on how multiple power electronics devices are connected to each other via a power line, without depending on preliminary wiring.

### BRIEF DESCRIPTION OF THE DRAWINGS

FIG. 1 is a view illustrating an overall system according to an embodiment;

FIG. 2 is a view illustrating a battery storage system according to an embodiment;

FIG. 3 is a view illustrating an EV system according to an embodiment;

FIG. 4 is a view illustrating a system of a plurality of power electronics devices according to an embodiment;

FIG. 5 is a view illustrating a connection format between power electronics devices according to an embodiment;

FIG. 6 is a block diagram of a power electronics device according to an embodiment;

FIG. 7 is a view illustrating hierarchical configuration information, communication connection information and power connection information according to an embodiment;

FIG. 8 is a view illustrating a connection configuration in a case where power electronics devices is connected to a system;

FIG. 9 is a view illustrating a connection configuration in a case where power electronics devices are not connected to a system;

FIG. 10 is a view to explain connection inspection method 1;

FIG. 11 is a view to explain connection inspection method 2;

FIG. 12 is a view to explain connection inspection method 3-1;

FIG. 12A is a view to explain connection inspection method 3-2;

FIG. 13 is a view to explain connection inspection method 4;

FIG. 14 is a view to explain connection inspection method 5;

FIG. 15 is a view to explain connection inspection method 6;

FIG. 16 is a view to explain connection inspection method 1;

FIG. 17 is a view illustrating a state where power electronics devices perform communication with each other via other media than a power line;

FIG. 18 is a configuration diagram of a power electronics device according to an embodiment of the present invention;

FIG. 19 is a view illustrating an alternation example of a power electronics device according to an embodiment of the present invention;

FIG. 20 is a view illustrating a specific example of a power electronics device;

FIG. 21 is a view illustrating a specific example of a power electronics device; and

FIG. 22 is a view illustrating that device identification information and inspection signals are exchanged between power electronics devices.

### DETAILED DESCRIPTION

According to one embodiment, there is provided a power electronics device including: a connection unit connected to a first power line; a communication unit; at least one unit of an electricity change unit and an electricity detection unit; and a control unit.

The communication unit performs communication with other power electronics devices.

The electricity change unit changes an energization state of the first power line and the electricity detection unit detects a change in the energization state of the first power line.

The control unit specifies a power electronics device connected to the first power line out of the other power electronics devices using the communication unit and said at least one unit of the electricity change unit and the electricity detection unit.

Hereinafter, embodiments will now be explained with reference to the drawings.

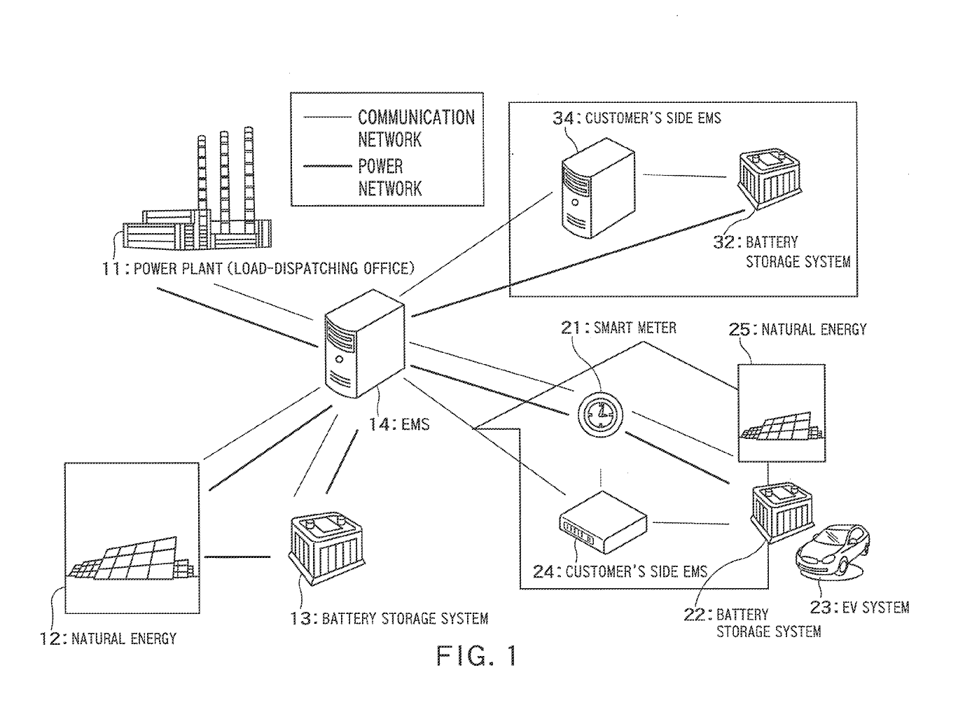

FIG. 1 presents a system configuration according to an embodiment. On a power system network, there are provided a power plant (or load-dispatching office) 11, a natural energy system 12, a battery storage system 13 and an EMS (Energy Management System) 14. Also, on the side of customers such as a home or building, there are provided a smart meter 21, battery storage systems 22 and 32, an EV (Electric Vehicle) system 23 and customer's side EMS's 24 and 34. The EMS 24 on the home customer side is referred to as “HEMS (Home Energy Management System)” and the EMS 34 on the building customer side is referred to as “BEMS (Building Energy Management System),” which manage the energy amount on premises. Also, a natural energy system 25 and the battery storage systems 22 and 32 are connected to inverters (i.e. power electronics devices) that convert the direct current and the alternating current. The inverters each are one exemplary embodiment of the power electronics device and other various embodiments of the power electronics device are also possible.

The power plant (or load-dispatching office) 11 generates a large amount of power by fuel sources such as thermal power and nuclear power, and supplies it to the side of customers such as homes, buildings and factories through transmission and distribution networks. In the present specification, the transmission and distribution networks from the power plant 11 to the customers are collectively referred to as “power system network.”

The natural energy system 12 generates power from energy existing in the natural world such as wind power and sunlight, and, in the same way as the power plant, supplies the power from the power system network to the customers through transmission and distribution networks. By installing the natural energy system 12 in the power system network, it is possible to reduce the burden in the power plant and efficiently perform an operation.

Here, the battery storage system 13 has a role to store surplus power generated in the power plant 11 and the natural energy system 12.

Also, the EMS 14 has a role to perform control of stabilizing the whole power system including supply power of the power plant 11 and the natural energy system 12 and load power consumed on the customer side, using both a power network and a communication network.

The smart meter 21 measures the electric energy consumed on the customer side premise and periodically reports it to a management server of an electric power provider. Generally, although the management server is referred to as “MDMS (Metering Data Management System),” Its illustration is omitted in FIG. 1. The EMS 14 can calculate the total amount of load power on the customer side in cooperation with the MDMS.

The battery storage system 22 installed in a customer's premise stores power supplied from the system network of the electric power provider or the natural energy system 25 on the premise. The EV system 23 stores power in an in-vehicle battery through a battery charger.

The HEMS performs adjustment control of the power consumption amount in the home and the BEMS performs adjustment control of the power consumption amount in the building or factory. As described above, the embodiments are applicable to not only the home but also the building or factory in the same way. In this case, as a substitute for the home HEMS, the BEMS performs adjustment control of the power consumption in the building and an FEMS (Factory Management System) performs adjustment control of the power consumption on the premise.

As the use on the system side of the electric power provider in the battery storage system 13, a battery storage system is utilized to realize a function called “ancillary service” (i.e. short-period control) that stabilizes a system by performing output adjustment on the second time scale according to instantaneous load changes in order to maintain the electrical quality such as system frequency or voltage.

Also, as the use of the battery storage system 22 on the home or building customer side, it may be utilized to realize a function called “peak shift” (i.e. day operation) that stores nighttime power of a lower unit price to implement interchange in a time zone in which the diurnal power use is peak.

Here, the power electronics device converts power between direct-current power input/output in/from the battery storage or the natural energy system and alternating-current power of the power system network.

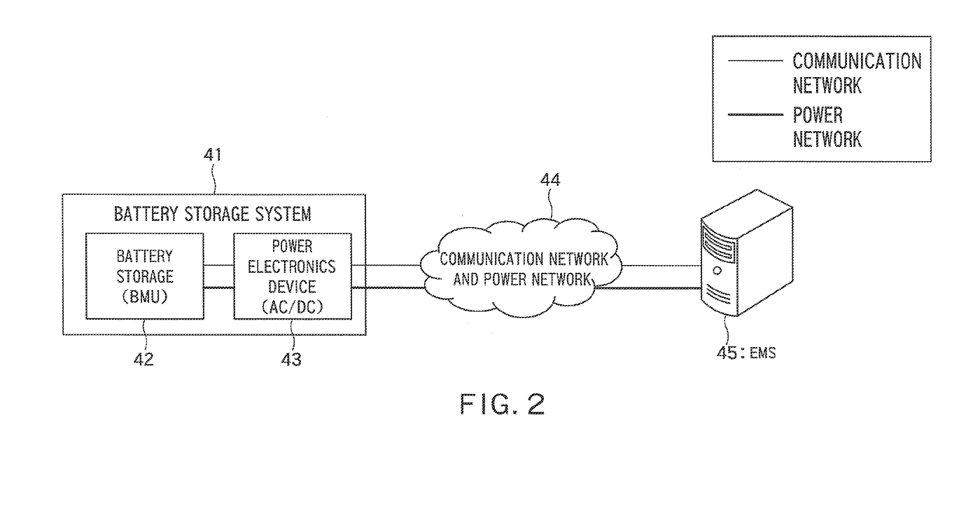

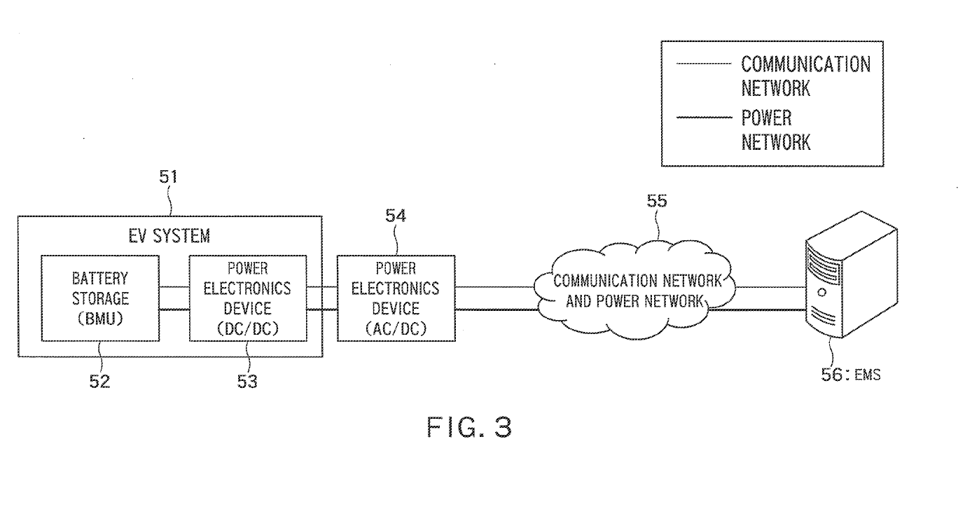

FIG. 2 and FIG. 3 illustrate basic system configurations of a power electronics device according to the embodiment. These are details of part of the system configuration in FIG. 1. FIG. 2 presents a detailed configuration of the battery storage system and FIG. 3 presents a derailed configuration of the EV system. It is basically assumed that a battery storage system 41 is used in a fixed position and an EV system 51 is used in a vehicle. Alternatively, for example, even if a battery storage 42 in the battery storage system 41 is replaced with a natural energy system such as wind power and solar power generation, the same system is applicable.

The battery storage system 41 in FIG. 2 is formed with a battery storage (BMU: Battery Management Unit) 42 and a power electronics device 43. The battery storage system 41 is connected to each EMS 45 disposed in a power grid system or on demander's premises via a communication network and power network 44. The power electronics device 43 is also called “inverter,” “converter” or “PCS (Power Conditioning System)” and therefore has a role to convert an input/output of power and adjust the voltage amount. The battery storage (BMU) 42 includes multiple battery cells and an internal processor to thereby manage the state inside a battery pack, and implements charge/discharge control of power based on a request from the power electronics device 43. The battery storage (BMU) 42 reports information such as the rated voltage, the maximum current value at the time of discharge and charge, the SOC (State Of Charge) and the SOH (State Of Health) to the power electronics device 43.

In the example of FIG. 2, the power electronics device 43 exchanges direct-current power with the battery storage 42 and alternating-current power with the power network. Although the power electronics device 43 performs direct-current/alternating-current conversion and voltage change suppression, it is considered that these functions themselves are implemented on a processor connected to the outside of the device.

Also, regarding procedures for the charge/discharge control and the information report between the battery storage (BMU) 42 and the power electronics device 43, in addition to a method of realizing them using a CAN (Controller Area Network), there is a possible method of realizing them using a wire communication medium such as Ethernet or a wireless communication medium such as a wireless LAN (Local Area Network), and, furthermore, an electrical signal line that is uniquely defined by a vendor who sells products. However, the embodiment is not limited to any communication unit.

The power electronics device 43 in the battery storage system 41 in FIG. 2 has a communication function and communicates with each EMS 45 installed in the power system network or the customer's premise. Generally, since a battery storage has a feature of self-discharge, by acquiring information such as SOC and SOH from the battery storage system 41, the EMS 45 can appropriately monitor the state that changes over time and instruct charge/discharge control.

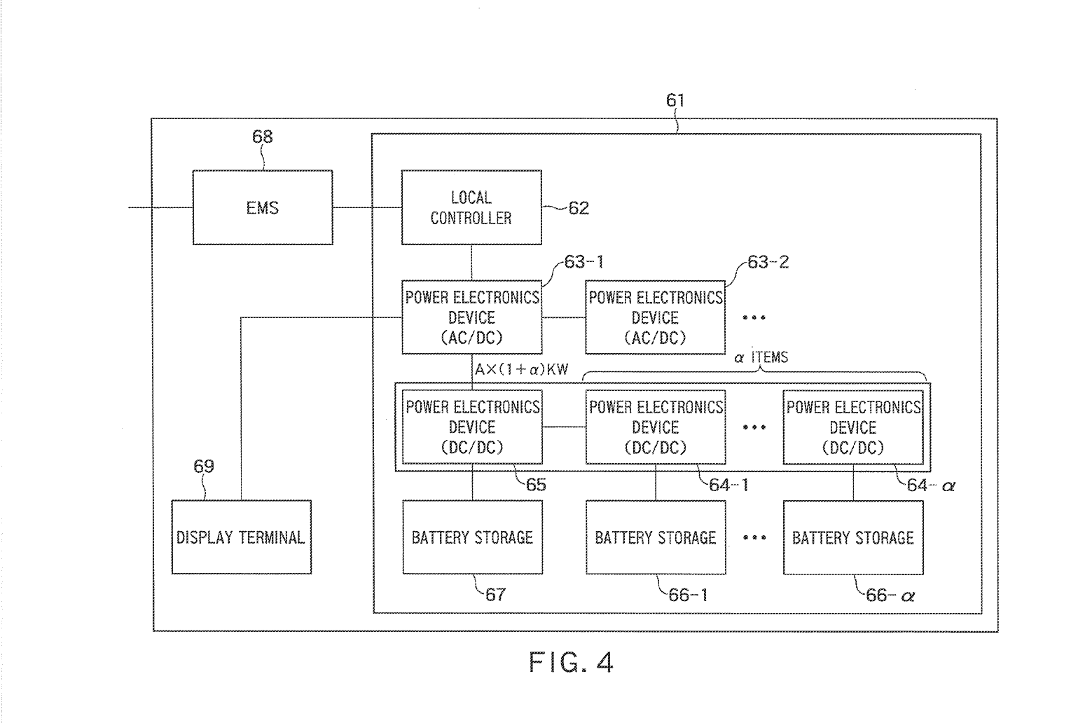

Here, an input/output of power through the power electronics device 43 may be referred to as “discharge and charge.” This means that not only the battery storage (BMU) 42 but also natural energy such as wind power and solar power generation and the power exchanged with the power system network are the targets in the embodiment. In an electrical system formed with aggregation of power electronics devices, although the power electronics devices have a role to switch the input/output direction of power, this is explained in detail in FIG. 4 below.

Although the EV system 51 in FIG. 3 employs a configuration similar to the battery storage system 41 in FIG. 2, they are different in that a power electronics device 54 operating as a battery charger exists in addition to a power electronics device 53 that is connected to the battery storage 52 and operates. The EV system 51 is connected to each EMS 56 disposed in a power grid system or on demander's premises through a communication network and power network 55.

The power electronics device 53 connected to the battery storage 52 in the EV system 51 in FIG. 3 relays power and communication information between the battery storage (BMU) 52 and the power electronics device (i.e. battery charger) 54. In this case, the power electronics device 53 does not necessarily have to have a communication capability to communicate with each EMS on the power system network or a customer's premise. That is, in the example of FIG. 3, there is a feature that an alternating-current/direct-current conversion function in the power electronics device 43 in the battery storage system 41 in FIG. 2 is shifted to the battery charger side corresponding to the power electronics device 54. That is, in the configuration in FIG. 3, the power electronics device 53 implements direct-current/alternating-current conversion and the power electronics device 54 implements direct-current/alternating-current conversion. However, a specific procedure to realize the embodiment is common in FIG. 2 and FIG. 3, and, furthermore, the role of the EV system 51 can be defined to the same role as the battery storage system 41. Further, although there are multiple formats that: algorithm processing related to discharge and charge with respect to the battery storage (BMU) is integrated into the power electronics device 53; the algorithm processing is integrated into the power electronics device (i.e. battery charger) 54; and the algorithm processing is integrated into HEMS/BEMS on a customer's premise or EMS in the power system network, the embodiment can be realized in the same framework even if any configuration is used.

FIG. 4 illustrates a system configuration view by multiple power electronics devices according to the embodiment. Such a system configuration can be arranged in any of the power system side and the customer side.

In the case of combining multiple storage batteries (or natural energy systems) and forming aggregation of power units, the aggregation includes one or multiple local controllers, power electronics devices (AC/DC or DC/DC) and storage batteries. In the example in the figure, a local controller 62, power electronics devices (AC/DC or DC/DC) 63-1, 63-2, 65 and 64-1 to 64-α and storage batteries 67 and 66-1 to 66-α are displayed in a power system 61 corresponding to the aggregation. Also, a line connecting element blocks illustrated in FIG. 4 shows a schematic hierarchical configuration between the elements, and does not necessarily correspond to an actual power line connection relationship.

In the case of such aggregation 61, communication between each external EMS 68 and the local controller 62 (the local controller itself can be omitted) corresponds to the examples in FIG. 2 and FIG. 3. EMS 68 or the local controller 62 realizes, as a control master, a power application such as control of active power or reactive power and control of allocation of output/input power amount. The EMS 68 and the local controller 62 correspond to examples of a higher-order control device. In the case of performing communication in multiple power electronics devices, it is possible to activate the multiple power electronics devices in parallel and realize a power application such as control of a phase synchronization of output power for an output increase of power. In the example in FIG. 4, when it is assumed that inputs/outputs of the power electronics devices 65 and 64-1 to 64-α are A kW, by activating 1+α items in parallel, a power input/output of A×(1+α) kW can be intended.

In the case of connection to a large power signal such as the power system network, a power electronics device does not especially have to exchange information for synchronization via a communication network and gradually synchronizes with the power network signal by electrical characteristics. However, a problem in a case where the scale of input/output electric energy is substantially constant and multiple items operate at the same time as illustrated in FIG. 4 is that, unless information of a target for synchronization is exchanged via a communication network, a power input/output intended by the user of the power electronics devices is not performed. Also, as illustrated in FIG. 4, by communicatively connecting a power electronics device (i.e. the power electronics device 63-1 in the example in FIG. 4) to a display terminal 69, it is possible to realize a power application for a data monitor, abnormal report or parameter adjustment.

Also, on the power system network side, to respond to an instantaneous load change, each battery storage generally supports a function called “ancillary service.” In this case, since it is necessary to secure a large storage capacity equal to a power plant, as illustrated in FIG. 4, it is desirable to install multiple distributed power sources (i.e. battery storage or natural energy system) connected to power electronics devices. Meanwhile, even on the customer side, it is a common practice to provide a function called “peak shift” to store nighttime power of a lower unit price to implement interchange in a time zone in which the diurnal power use is peak. In addition to this, it can be considered to apply an application in which, under a condition to give a certain incentive to the customer side, an electric power provider uses the storage batteries installed on the customer side or power of natural energy. In these uses, regarding the subject of the control right, since power storage and power interchange simultaneously occur in a case where there are multiple users, a system configuration is assumed in which there are multiple control subjects and uncontrolled subjects together.

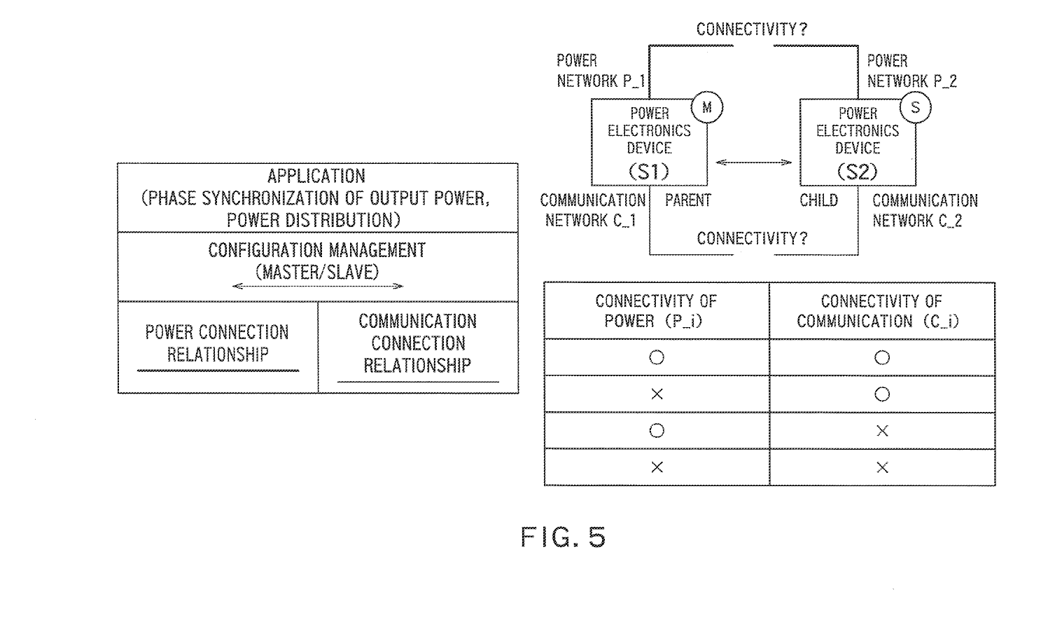

FIG. 5 presents a conceptual view related to a connection relationship between a plurality of power electronics devices according to an embodiment. As illustrated in the example of the figure, the power electronics devices can realize different applications (e.g. phase synchronization of output power and allocation of output/Input power amount) depending on the intended purpose, and, furthermore, there may be a case where the communication connection relationship and the power connection relationship do not have a one-to-one correspondence with each other.

For example, a set of power electronics devices is defined as S and subsets of S are defined as S1 and S2 (S1∪S2=S, S1∩S2=0). It is assumed that a power electronics device of Si (i=1, 2) is connected to power network Pi and communication network Ci. As Illustrated in FIG. 5, there are totally four kinds of relationships between communication connection and power connection.

That is, there are relationships where: [1] power connection is established (O) and communication connection is established (O); [2] power connection is not established (x) and communication connection is established (O); [3] power connection is established (O) and communication connection is not established (x); and [4] power connection is not established (x) and communication connection is not established (x).

Depending on each of these four states, it is discussed how cooperative power interchange can be performed among power electronics devices. For example, even if the communication connection relationship is established, in a case where the power connection relationship is not established, since two power electronics devices are not connected to the same power bus line, it is not necessary to perform synchronization processing for allocation of output/Input power amount and phase synchronization of output power. Furthermore, when there is scheduled a power allocation of output/input power amount between these two devices, it may be difficult to perform adaptive control in a power system. For example, in the case that master/slave is determined between the two devices, even if a master power electronics device receives an output instruction of predetermined power from a higher device and gives an allocation of output/input power amount instruction (e.g. an instruction to transmit half power of the predetermined power to the master) to a slave power electronics device, it is not possible to output the requested power to the master since the slave power electronics device is not actually connected to the same power bus line as that of the master. Therefore, the master cannot receive the requested power from the slave to which the instruction was given, and cannot adequately execute an instruction from the higher device.

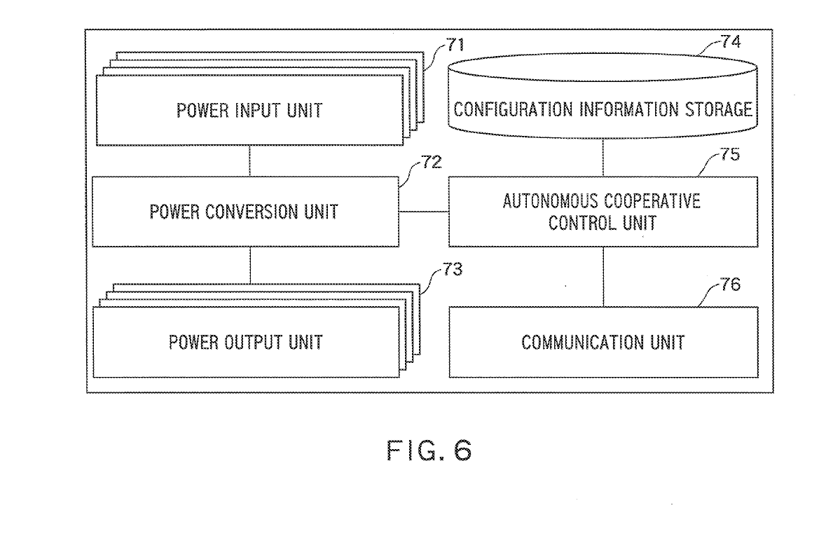

FIG. 6 presents a configuration example of a power electronics device according to the embodiment. As described above, the power electronics device corresponds to the power electronics device in the power system in FIG. 4. Alternatively, it corresponds to the power electronics device connected to the battery storage (BMU) in the power battery system in FIG. 2. Alternatively, it corresponds to the power electronics device 53 connected to the battery storage (BMU) in the EV system in FIG. 3 or the power electronics device 54 connected to the battery charger. Further, the embodiment is similarly applicable to the case of connection to a natural energy system such as solar power generation and wind power generation. In FIG. 6, a configuration concerning power converting in the inverter which performs conversion of AC/DC, AC/AC or DC/DC is especially shown as well as a configuration concerning cooperative operation with other devices.

In the embodiment, by causing multiple converters having a communication function to act in an autonomous cooperative manner and determine a master/slave relationship, it is possible to maintain the flexibility of installation locations while automatically increasing the capacity and maintaining the total charge/discharge power throughput amount of distributed power sources at the time of expansion and maintenance. It is needless to say that part or all of components in FIG. 6 are not limited to be applied to a power electronics device but are similarly applicable to an EMS or a local controller and can be implemented.

The power electronics device in FIG. 6 is formed with power input units (i.e. power connection units) 71, a power conversion unit 72, power output units (i.e. power connection units) 73, a configuration information storage 74, an autonomous cooperative control unit 75 and a communication unit 76. The power input units 71 and the power output units 73 are connected to power lines and connected to other devices (e.g. discharge device such as a power electronics device, controller, EMS, battery storage and natural energy system) via the power lines.

Specifically, the power input units 71, the power conversion unit 72 and the power output units 73 play roles of direct-current/alternating-current, direct-current/direct-current or alternating-current/alternating-current power conversion, frequency monitoring and adjustment of power and change detection and adjustment of voltage. In the example in the figure, although there are multiple power input units 71 and power output units 73, the number of each of them may be one in actual implementation.

In actual implementation, in a case where a power electronics device is connected to a battery storage (BMU), there are two methods that: power from the battery storage (BMU) is input in the power input units 71 via the power lines; and power Input from the power lines are output from the power output units 73 to the battery storage (BMU) side via the power lines. Regarding the power Input units or the power output units, in addition to a method of preparing each of them as a physical circuit, a method of commonly preparing them in the same circuit is possible. By this means, the power electronics device implements charge/discharge control with respect to the natural energy system or the battery storage (BMU).

Even when any of the electric energy expressed in Wh (Watt hour), the electric energy expressed in Ah (Ampere hour) and the electric energy expressed in Vh (Volt hour) is used as the electric energy at the time of charge/discharge control, the embodiment can be similarly implemented.

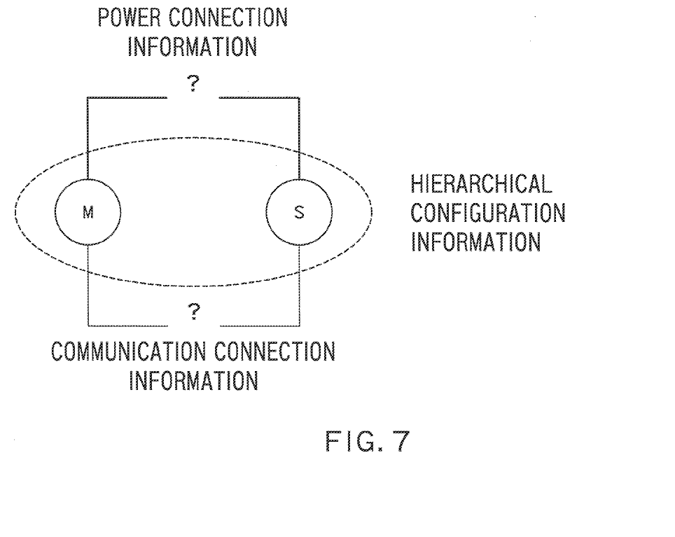

In the embodiment, the configuration Information storage 74 stores three kinds of information of hierarchical configuration information, power conversion characteristic information and operation plan information as shown in FIG. 7. Other information than these three kinds of information can be used as information stored in the storage 74.

In view of the power electronics device, the hierarchical configuration information indicates information of a master (parent) device and slave device. In the example of FIG. 7, it is illustrated such that a power electronics device on the left side is the master (M) and a power electronics device on the right side is the slave (S).

The communication connection information denotes information indicative of whether it is possible to perform direct communication between two devices. To be more specific, the communication connection information indicates a wire connection state in the case of wire communication and a radio propagation range state in the case of wireless communication. By extension, the communication connection information can include a case where communication connection is possible through any of the devices.

The power connection information denotes information as to whether power lines are in a wire connection state between two devices, that is, whether the same bus line is shared. Regarding this, a plurality of items may be managed every format of power exchanged between devices, such as wire connection by direct current and wire connection by alternate current. For example, regarding specific device types to determine a master and a slave, there is information as to alternate current/alternate current (AC/AC), alternate current/direct current (AC/DC) and direct current/direct current (DC/DC). One of features of the present embodiment aims to automatically acquire power connection relationship of power electronics devices

Here, the power electronics device may have a unique physical device configuration per power conversion function or functions may be commonalized. For example, in the case of commonalizing the functions, the power electronics device can perform not only alternating-current/direct-current (AC/DC) conversion but also direct-current/direct-current (DC/DC) conversion. At this time, regarding expression of the power conversion characteristic information, there are a method of describing all possible power conversion functions and a method of performing description in association with a role determined at the time of actually connecting to a power line and inputting/outputting power. In the case of connection to at least one bus line (or device on the bus line) for alternating current and connection to at least one bus line (or device on the bus line) for direct current, power conversion characteristic information of the power electronics device describes alternating-current/direct-current (AC/DC), for example. In the case of only one type of them, it describes alternating-current/alternating-current (AC/AC) or direct-current/direct-current (DC/DC), for example.

The autonomous cooperative control unit 75 in FIG. 6 detects a configuration change related to other devices (e.g. attachment/detachment of a device and addition/removal/stop/restart of a device function), updates the hierarchical configuration information, the power conversion characteristic information and the operation plan information in the configuration information storage 74 and manages an input and output of power. Also, autonomous cooperative control unit determines that power electronics devices connected to the same bus line each operate as which of master or slave based on power connection Information

The communication unit 76 in FIG. 6 plays a role of generating information such as hierarchical configuration Information, communication connection information and power connection information as communication messages and transmitting/receiving them through an EMS, local controller, other power electronics devices or communication network. In addition to a case where the communication unit 76 performs processing of transmitting/receiving a communication message, there is a case where it has a first communication unit and a second communication unit as communication media.

For example, the first communication unit is realized by a wireless communication medium such as IEEE802.11, Bluetooth and ZigBee, in addition to a wire communication medium such as an optical fiber, telephone line and Ethernet. A communication medium in the present embodiment does not depend on a specific communication medium. The power electronics device acquires communication messages from the EMS, the local controller and other power electronics devices through the first communication unit.

Meanwhile, the second communication unit acquires characteristic information (such as rated capacity, charge/discharge start/end voltage, upper limit temperature, lower limit temperature, maximum charge/discharge current and rated voltage) which is unique information of the battery storage (BMU) or natural energy system connected to the power electronics device, and further acquires measurement Information or setting information during operation. In a case where the battery storage (BMU) is connected to the power electronics device, measurement Information (such as SOC, SOH, charge/discharge current and charge/discharge voltage) which is variation information at the time of an operation of the battery storage (BMU) is periodically acquired. The second communication unit can be realized by CAN which is a general interface standard of the battery storage (BMU), a wired/wireless communication medium such as Ethernet or an electrical signal line uniquely assumed by a vendor who handles manufacture of a battery storage system, while the embodiment does not depend on a specific medium.

Also, in a case where the battery storage is connected to the power electronics device, since an internal battery cell generally has a feature of self-discharge, at the time of transmitting information such as SOC and SOH to the EMS, the local controller or other power electronics devices, it is not necessarily completed by only one transmission. Similar to information of voltage or current, it is desirable to timely report it taking into account a feature that the value changes over time. The power electronics device is not limited to be connected to the battery storage (BMU), can be connected to solar power generation and wind power generation or various EMS's and local controller that communicate with them.

One of features of a power electronics device according to the present embodiment lies in that, even if the power connection configuration of power electronics is changed, it is possible to specify power electronics devices connected to same power line as that connected to the owe device and automatically understand the power connection relationship of the power electronics devices. As a result of this, even if the power connection configuration of the power electronics is changed, it is possible to automatically update the above-mentioned power connection information and maintain the content of the information in a correct state.

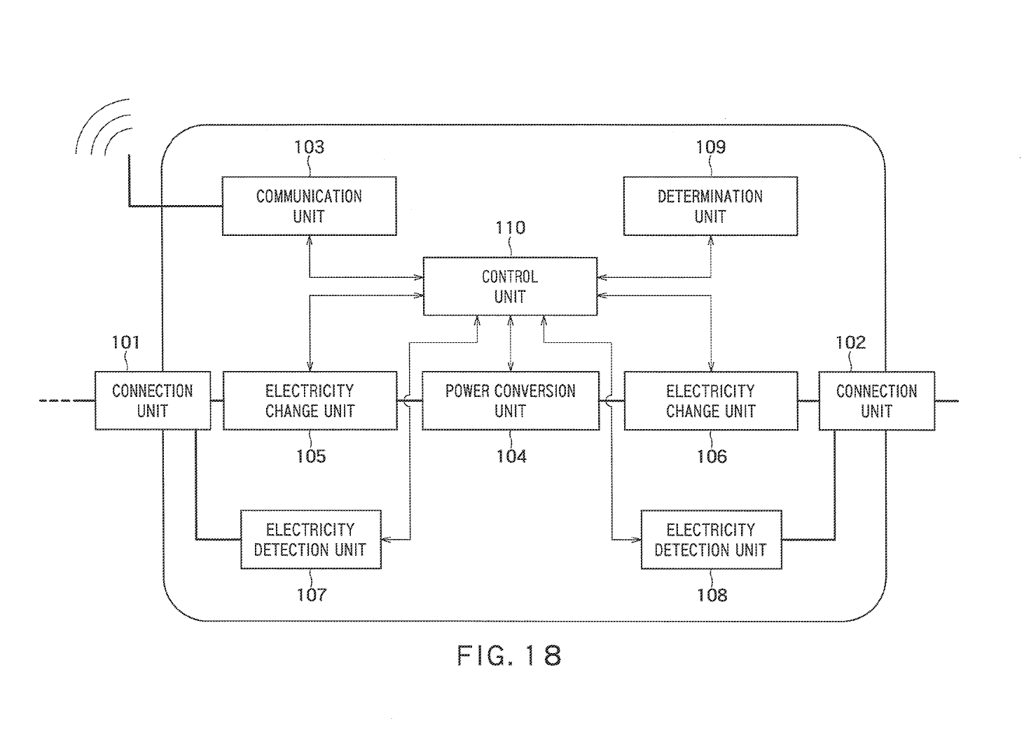

FIG. 18 is a block diagram showing a configuration of components related to the automatic acquisition of a power relationship connection in a power electronics device.

A first connection 101 is connected to a power line and a second connection 102 is connected to a power line different from the first connection unit.

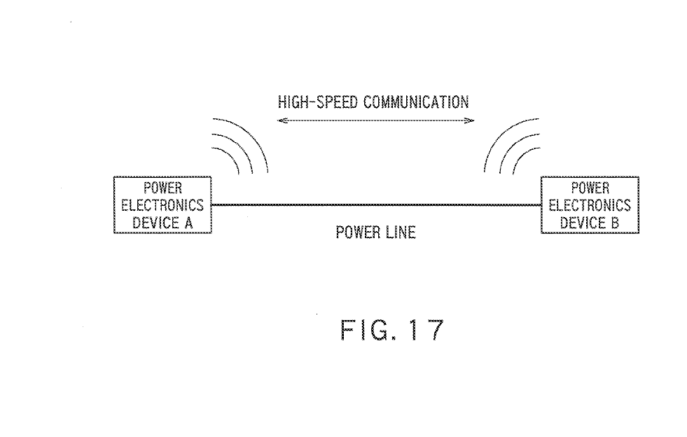

A communication unit 103 performs wireless communication with other power electronics devices. FIG. 17 illustrates a state where wireless communication is performed between two power electronics devices connected by a power line. Wire communication using a wired network may be used instead of wireless communication. The power line communication may be used as the wire communication. In the case of using other communication lines than the power line, it is possible to avoid the failure by noise caused in the power line communication. To avoid the noise failure, a configuration to perform communication using a communication medium different from the power line may be adopted.

A power conversion unit 104 converts power input from one of the first and second connection units and outputs it from the other connection unit. As a conversion example, there are AC/AC conversion, DC/DC conversion and AC/DC conversion.

A first electricity change unit 105 changes the energization state of the power line connected to the first connection 101. As the energization state change, the power line is changed from non-energized state (non-conductive state) to the energized state (conductive state) or the characteristic of an electrical signal that energizes the power line is changed. As an example of the characteristic change, the electricity such as the current and the voltage is changed, the load is varied (e.g., open, short-circuit or change to specific impedance) or the current value and the voltage value is varied from a predetermined value. A second electricity change unit 106 changes the energizing state of the power line connected to the first connection 101. The way of the change is similar to an example of the first electricity change unit 105.

A first electricity detection unit 107 detects the change of the energization state of the power line connected to the first connection 101. As the energization state change, for example, the change from non-energized state to the energized state in the power line or the change of the characteristic of an electrical signal conducted (propagated) in the power line is detected. The first electricity detection unit 107 may store detected Information in a non-illustrated Internal or external storage in association with the detection time. The energization state change is synonymous with the one described in the first or second electricity change unit. A second electricity detection unit 108 detects the change of the energization state of the power line connected to the second connection unit. The second electricity detection unit 108 stores detected information in a non-illustrated internal or external storage in association with the detection time.

A determination unit 109 specifies a power electronics device connected to the same power line with the first connection 101 or the second connection 102, using information acquired in the communication unit 103, the electricity detection units 107 and 108 and the electricity change units 105 and 106 under the control of a control unit 110.

The control unit 110 executes and controls a connection inspection procedure to understand the power electronics device connected to the same power line as the first or second connection unit by controlling each of the components 103 to 109 in the device.

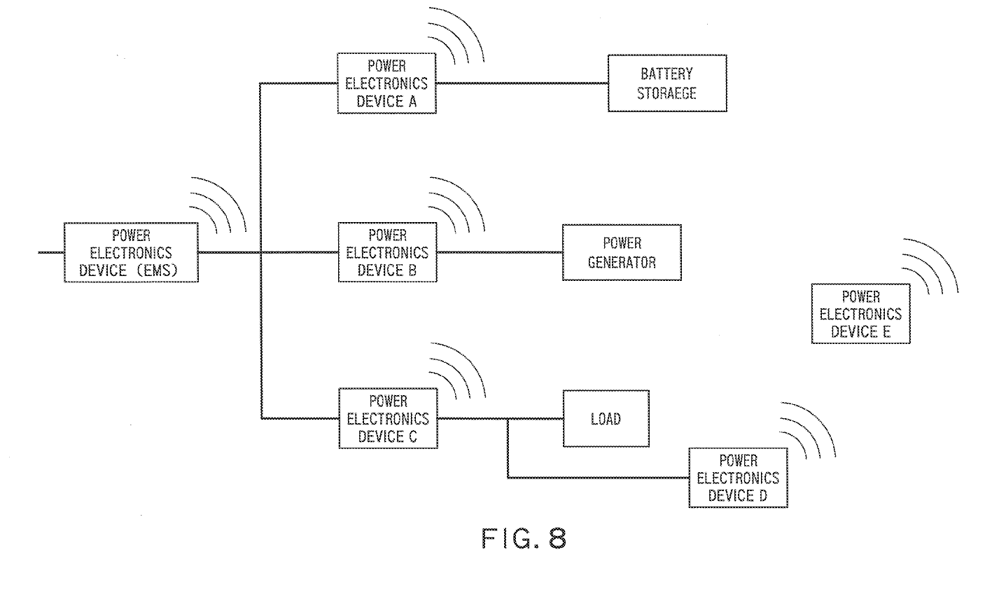

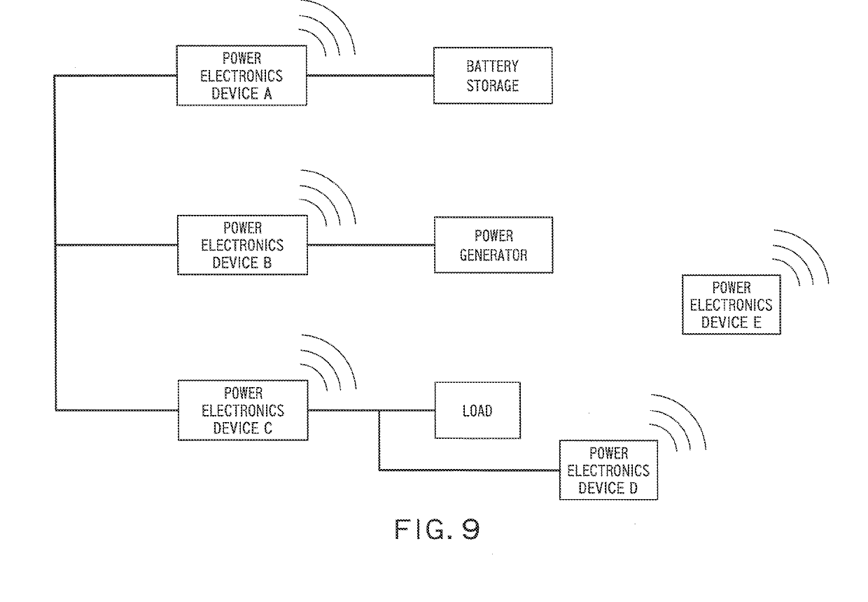

A specific example of the connectivity inspection procedure by a power electronics device according to the present embodiment is described using the connection configuration of power electronics devices as illustrated in FIG. 8 or FIG. 9 as an example. FIG. 8 illustrates a configuration in a case where the power electronics devices are connected to a power system such as a power grid system. FIG. 9 illustrates a configuration in a case where the power electronics devices are not connected to the power system.

FIG. 8 illustrates a power electronics device (EMS) and power electronics devices A, B, C, D and E which can perform wireless communication with each other. The power electronics device (EMS) is an EMS on the customer side such as an HEMS and a BEMS, and the power electronics device (EMS) is connected to the system in the first connection unit. Moreover, the power electronics device (EMS) is connected to power electronics devices A, B and C in the home or factory by the same bus line (power line) in the second connection unit. Here, it does not matter if the power electronics device (EMS) is an EMS on the system side and power electronics devices A, B and C are directly connected to the EMS on the system side. Moreover, the present embodiment is also applicable to power electronics devices without the EMS.

Power electronics device A is connected to the same power line as the power electronics device (EMS) in the first connection unit and connected to another power line in the second connection unit. A battery storage is connected to this power line. That is, power electronics device A is connected to the same bus line (power line) as the battery storage.

Power electronics device B is connected to the same bus line as the power electronics device (EMS) in the first connection unit and connected to another power line in the second connection unit. A power generator is connected to this power line. That is, power electronics device B is connected to the same bus line (power line) as the power generator.

Power electronics device C is connected to the same bus line as the power electronics device (EMS) in the first connection unit and connected to another power line in the second connection unit. A load (such as illumination) is connected to this power line and further connected to power electronics device D. That is, power electronics devices C and D and the load are connected to the same bus line (power line).

Power electronics device E denotes a power electronics device belonging to a group different from the group of the power electronics device EMS and power electronics devices A, B, C and D, or denotes a power electronics device that is not connected to any power line and exists alone. For example, a situation is considered where a manager being human does not connect power electronics device E to any power line.

Although power electronics devices A, B and C are connected to the system side through the power electronics device (EMS) or directly connected to the power electronics device (EMS) on the system side in FIG. 8, power electronics devices A, B and C are directly or indirectly connected to the system side in the configuration of FIG. 9. Other conditions are similar between the configuration of FIG. 9 and the configuration of FIG. 8.

In the following, using the connection configurations illustrated in FIG. 8 and FIG. 9 as an example, an explanation is given to a specific procedure example where the power electronics device illustrated in FIG. 18 performs a connection inspection procedure and automatically understands the power connection relationship.

The connection inspection uses communication with other power electronics devices by the communication unit 103 and the change of the energization state with respect to the power line. It is roughly classified into three cases depending on which of the communication and the energization state change is performed first and whether they are performed at the same time.

<Case where Communication is Performed First and Energization State is Changed Later>

In a case where communication is performed first, for example, following two kinds of methods 1 and 2 are considered.

### [Method 1]

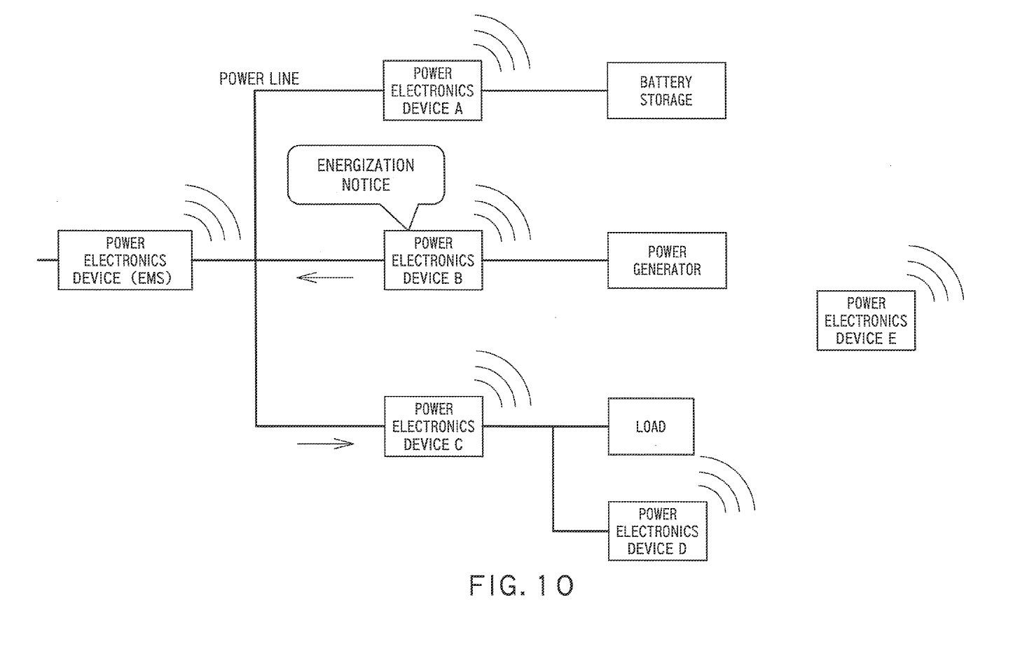

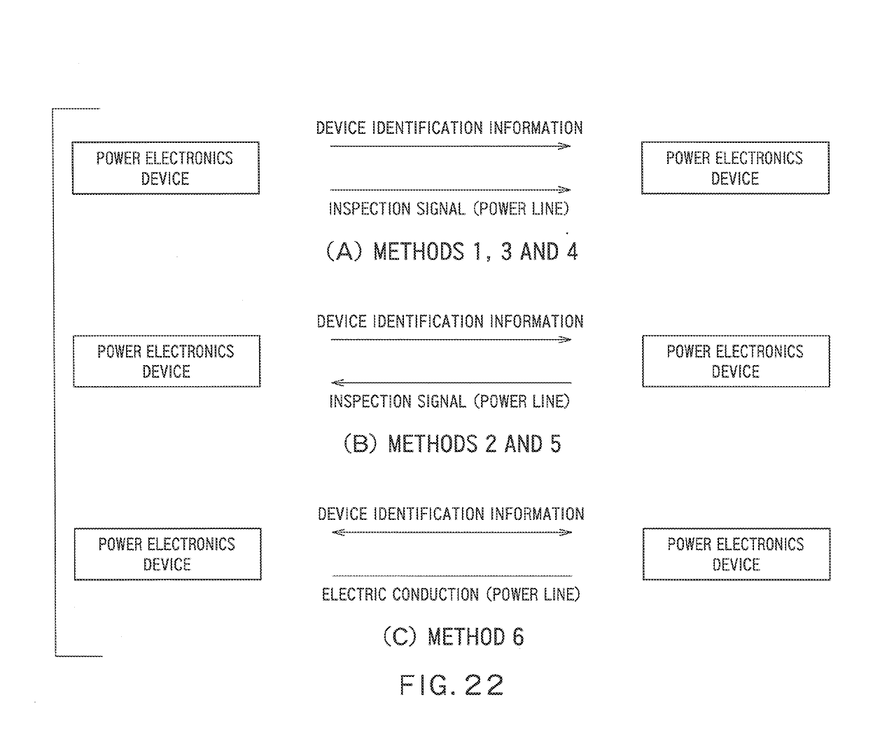

In the first method, a power electronics device first notifies (announces) to peripheral power electronics devices by communication that the device energizes an inspection signal to a power line for a certain period of time. After the notification, the power electronics device performs the energization of an inspection signal to the power line. That is, as illustrated in FIG. 22(A), notification including device identification information of a power electronics device is transmitted from the device, and, after that, an inspection signal is output from the same device to the power line. A power electronics device having received the notification and the inspection signal can understand the power connection relationship. For example, as Illustrated in FIG. 10, in a state where the power line to which the first connection unit is connected is not energized, power electronics device B notifies to peripheral power electronics devices by communication that the device energizes the power line for a certain period of time.

The power electronics devices having received the notification stand by for the notification period with respect to its connected power line and inspects whether the power line is energized. It is possible to use a voltage sensor or a current sensor for the inspection of energization. For example, power electronics device C inspects whether the power line connected to the first connection unit and the power line connected to the second connection unit are energized. Here, the notification signal includes identification Information of a power electronics device of the notification source. A configuration is possible where the notification signal includes the designation of a connection unit to be inspected and only the connection unit is inspected. The signal notification may be simply announcement of energization or communication that establishes consensus before energization between related power devices.

The power electronics device having detected the energization within the certain period of time can understand that it is connected to the power electronics device having performed the notification via the power line. In an example of FIG. 10, the power electronics device (EMS) and power electronics devices A and C correspond to such a power electronics device. The power electronics device (EMS) understands that it is connected to the same power line as power electronics device B in the second connection unit, and updates its held power connection information.

A power electronics device having not detected the energization within the certain period of time can understand that it is not connected to the power electronics device having performed the notification via the power line. In the example of FIG. 10, power electronics devices D and E correspond to such a power electronics device.

Also, when the power electronics device having received the notification and the inspection signal replies a signal showing the receipt of the inspection signal by communication, the power electronics device of the inspection signal issue source can also understand the power connection state.

Moreover, by monitoring both of the above-mentioned inspection signal and the reply, other power electronics devices than the above-mentioned two power electronics devices can also understand the power connection relationship. Moreover, by monitoring both of the above-mentioned notification and the reply, other devices having a communication function than the above-mentioned two power electronics devices can also understand that there is the power connection relationship between the above-mentioned two power electronics devices.

A power electronics device having understood a new power connection relationship can report the update of power connection information to peripheral power electronics devices. For example, the power electronics device (EMS) and power electronics devices A and C report power connection information that newly reflects the connection with the same power line as power electronics device B to the surroundings. As a result of this, for example, power electronics device B can understand that it is connected to the same power line as the power electronics device (EMS) and power electronics devices A and C in the first connection unit. Based on this, power electronics device B can update its held power connection information. Here, at the time of report to the surroundings, it is also possible to transmit only information on the updated part instead of transmitting all of updated power connection information. Here, power electronics devices D and E may receive the reported information and store it internally.

Here, it is not premised that the connection inspection by energization in methods 1 to 5 is not necessarily performed before the start of cooperative operation. However, in a case where the inspection is implemented before power exchange according to the cooperative operation is performed, there is an advantage that the detection is easy because a clear signal (that can be easily discriminated) such as the ON/OFF of voltage can be used as an inspection signal exchanged through a power line. On the other hand, in a case where the inspection signal is exchanged after the start of power exchange according to the cooperative operation, characteristic electric change (e.g., change of the voltage or current from a predetermined value, application of the voltage of a characteristic waveform, short-circuit, open or change of impedance) is caused as the inspection signal.

In the following, an example of flowing an inspection signal into a power line after the start of cooperative operation is shown.

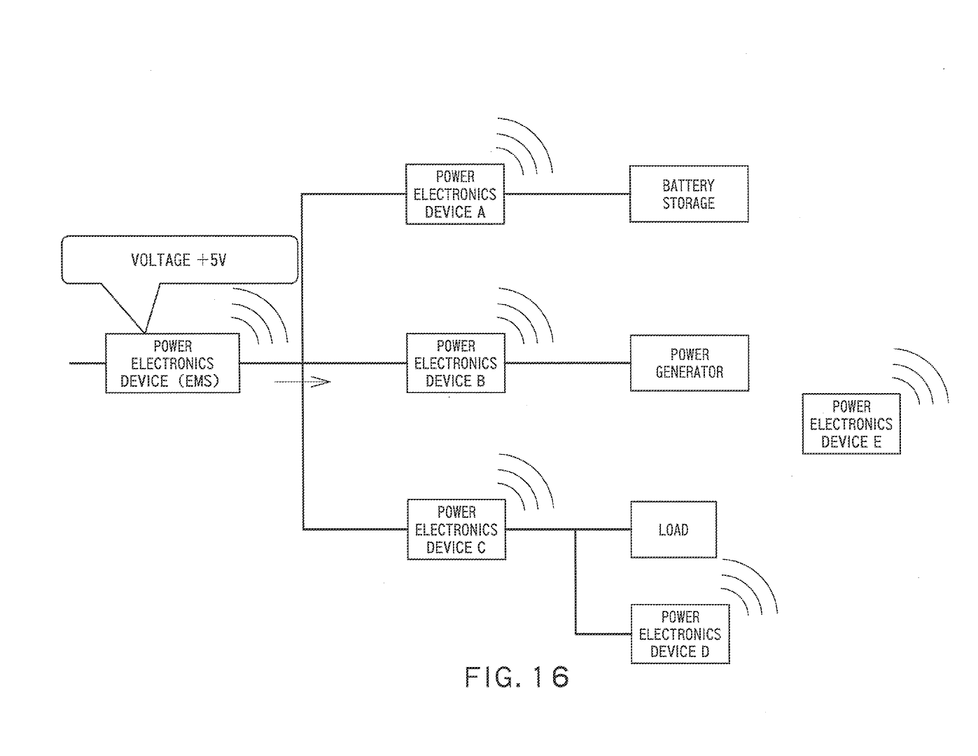

For example, as illustrated in FIG. 16, the power electronics device (EMS) raises the output voltage to the power line connected to the second connection unit by 5 V and advertises information on the voltage rise to the surroundings. Power electronics device B receives the information and inspects whether the voltage rises by 5 V within a certain period of time before the reception. Here, power electronics device B internally records the state of the voltage or the like in the power line. By confirming a voltage rise of 5 V by the power line connected to the first connection unit, power electronics device B determines that it is connected to the same power line as the power electronics device (EMS). To be more specific, it determines that the first connection unit of power electronics device B and the second connection unit of the power electronics device (EMS) are connected through the same power line. Although power electronics device B has been described here, the same applies to other power electronics devices A and C. It determines that power electronics devices D and E can receive an advertisement but cannot detect the voltage change and are not connected to the same power line as the power electronics device (EMS).

Thus, this method is an effective method even during cooperative operation if the load change level or the change period is within the acceptable range. Therefore, in a case where the connection configuration of power wire lines is changed after the start of operation, it is possible to understand the changed configuration without stopping the operation.

Each of this method and methods 2 to 6 described later is a method of combining communication and energization change and acquiring the power connection relationship. Power connection information acquired once can be transmitted to other power electronics devices by communication without using a power line thereafter. As a result of this, it is possible to share the power connection information more efficiently.

### [Method 2]

In the second method, a power electronics device designates one power electronics device with which communication is possible and requests it to perform energization, and the power electronics device having received the request energizes a power line. That is, as illustrated in FIG. 22(B), a power electronics device transmits a communication signal including device identification information of the device and the destination device, and, after that, the power electronics device having received the communication signal outputs an inspection signal from a power line. Communication about the receipt of the energization request may be performed by communication before the energization. The power electronics device of the request source designates the power electronics device which is known to be able to perform communication and which is unknown to be connected to a power line, as the request destination of energization.

In a case where the power electric device of the request source can detect the energization of an inspection signal, it decides that it is connected to the power electronics device of the request destination through the power line connected to a connection unit in which the energization is detected. In a case where the inspection signal is not detected in a certain period of time, it decides that it is not connected to the request destination through the power line.

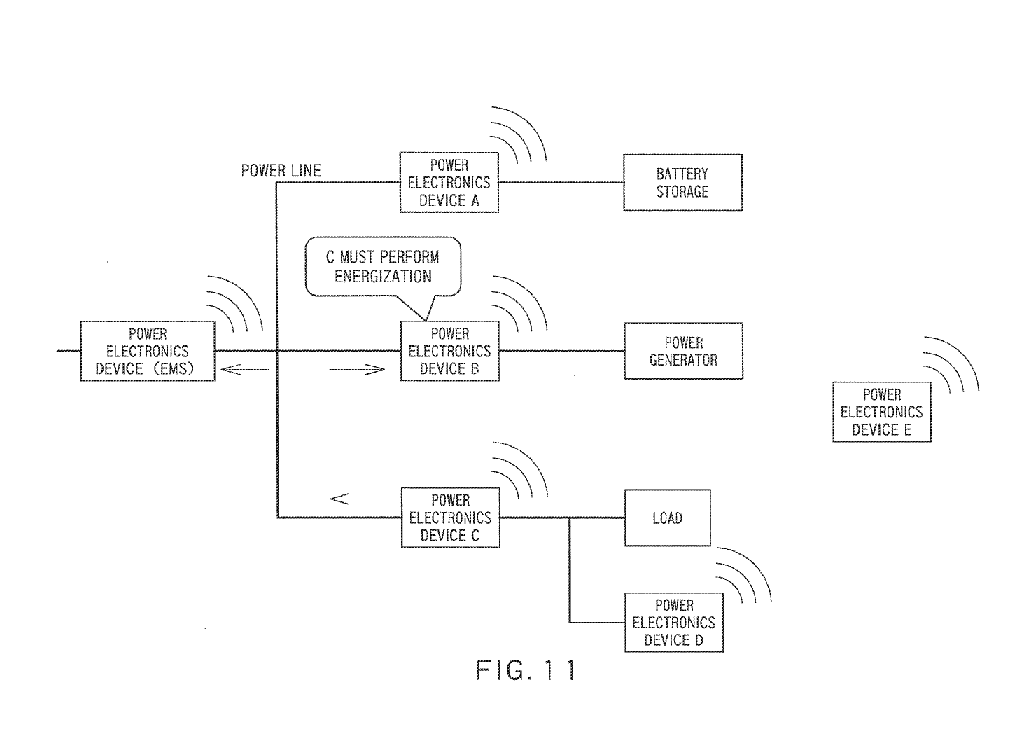

For example, as illustrated in FIG. 11, power electric device B knows that it is possible to perform communication with power electric device C but does not know whether it is connected through a power line, and therefore it requests power electric device C to perform energization from the first connection unit. In a case where power electric device B can detect the energization, it decides that power electronics device C of the request destination is connected through the power line connected to the connection unit in which the energization is detected. Here, the inspection signal can include the identifier of the power electronics device that performed the energization.

In preparation for a case where communication of the energization request fails due to packet loss or the like, the power electronics device having received the request has to perform communication about the receipt of the request in parallel with the energization. It is assumed that the request of the energization and the notification of the receipt can also be received by other power electronics devices than the request source and the request destination. Power electronics devices (in this example, the power electronics device (EMS) and power electronics devices A, D and E) having detected an energization request directed to other devices do not perform energization.

Moreover, by replying a signal by communication where the signal shows that the power electronics device has received the inspection signal, the power electronics device of the Inspection signal issue source can also understand the power connection state. Moreover, by monitoring both of the above-mentioned inspection signal and the reply, other power electronics devices than the above-mentioned two power electronics devices can also understand the power connection relationship. Moreover, by monitoring both of the above-mentioned request and the reply, other devices having a communication function than the above-mentioned two power electronics devices can also understand that there is the power connection relationship between the above-mentioned two power electronics devices.

Depending on whether the inspection signal is detected, other power electronics devices than power electronics device C of the request destination can also decide whether there is connection with the power electronics device of the request destination through the power line. A power electronics device having understood a new power connection relationship can report the update of its own power connection information to peripheral power electronics devices.

<Case where Communication and Change of Energization State are Simultaneously Performed>

The present method (method 3) is to perform connection inspection by performing energization notification and energization of an inspection signal at the same time. There are method 3-1 that simultaneously performs energization and advertises its own device identification information and method 3-2 that simultaneously performs energization and requests a reply of device identification Information to a power electronics device having detected the energization (the request may not be required to include device identification Information of the own device).

In method 3-1, for example, a power electronics device simultaneously notifies execution of energization to the surroundings by communication and starts energization of an inspection signal. That is, as illustrated in FIG. 22(A), a power electronics device simultaneously transmits a notification including device identification information of the device and outputs an inspection signal from the same power electronics device to a power line. A power electronics device having received the notification decides whether to be connected to the power electronics device of the notification source through the power line, depending on whether energization is detected within a certain period of time from the reception of the notification. The power electronics device having received the notification refrains from performing energization, stands by and tries to detect energization.

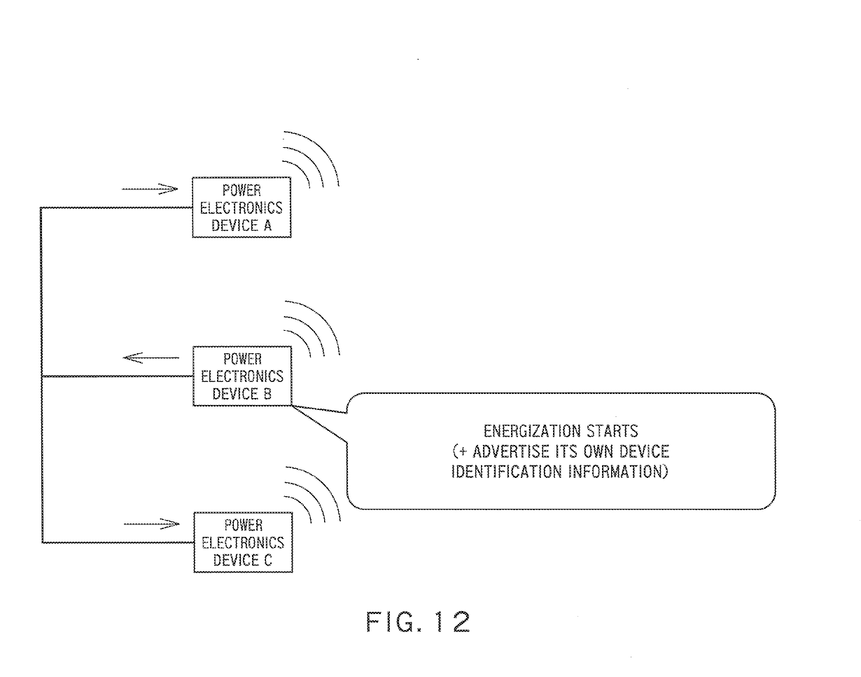

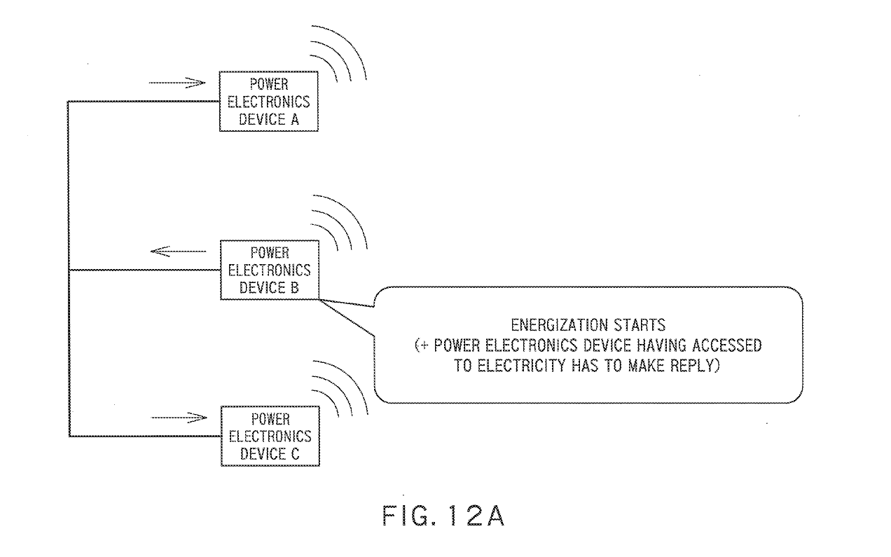

In the example illustrated in FIG. 12, power electronics device B notifies the start of energization to the surroundings. Power electronics devices A and C detect energization of an Inspection signal from a power line and understand the connection with power electronics device B in the power line. Power electronics devices A and C may make a reply about the energization detection to power electronics device B. That is, when the power electronics device having received the notification and the inspection signal replies a signal showing the receipt of the inspection signal by communication, the power electronics device of the inspection signal issue source can also understand the power connection state. Moreover, by monitoring both of the above-mentioned inspection signal and the reply, other power electronics devices than the above-mentioned two power electronics devices can also understand the power connection relationship. Moreover, by monitoring both of the above-mentioned notification and the reply, other devices having a communication function than the above-mentioned two power electronics devices can also understand that there is the power connection relationship between the above-mentioned two power electronics devices. Power electronics devices A and C that newly understand the power connection relationship can report the update of power connection information to a peripheral power electronics device.

In method 3-2, for example, a power electronics device simultaneously transmits a notification about execution of energization to the surrounding by communication, which includes a reply signal (this notification does not have to include its own device identification Information), and starts the energization of an inspection signal. A power electronics device having received the notification decides whether to be connected to the power electronics device of the notification source through a power line, depending on whether energization is detected within a certain period of time from the reception of the notification. The power electronics device having received the notification refrains from performing energization, stands by and tries to detect energization. The power electronics device having detected the energization advertises a reply about the energization detection, which includes its own device identification Information.

In the example illustrated in FIG. 12A, power electronics device B notifies the start of energization to the surroundings. It is assumed that a notification signal includes a reply request with respect to a power electronics device having detected the energization but does not include device identification information of the device. Power electronics devices A and C detect the energization of an inspection signal from the power line and send a reply about the detection of energization. When the power electronics device having received the notification and the inspection signal replies a signal showing the receipt of the inspection signal by communication, power electronics device B of the inspection signal issue source can also understand the power connection state. Power electronics device B that newly understands the power connection relationship can report the update of power connection information to peripheral power electronics devices.

<Case where Change of Energization State is Performed First and Communication is Performed Later>

In the following methods, connection inspection is performed by performing energization of an inspection signal first and performing communication later. It is also possible to use other methods than the methods described below.

### [Method 4]

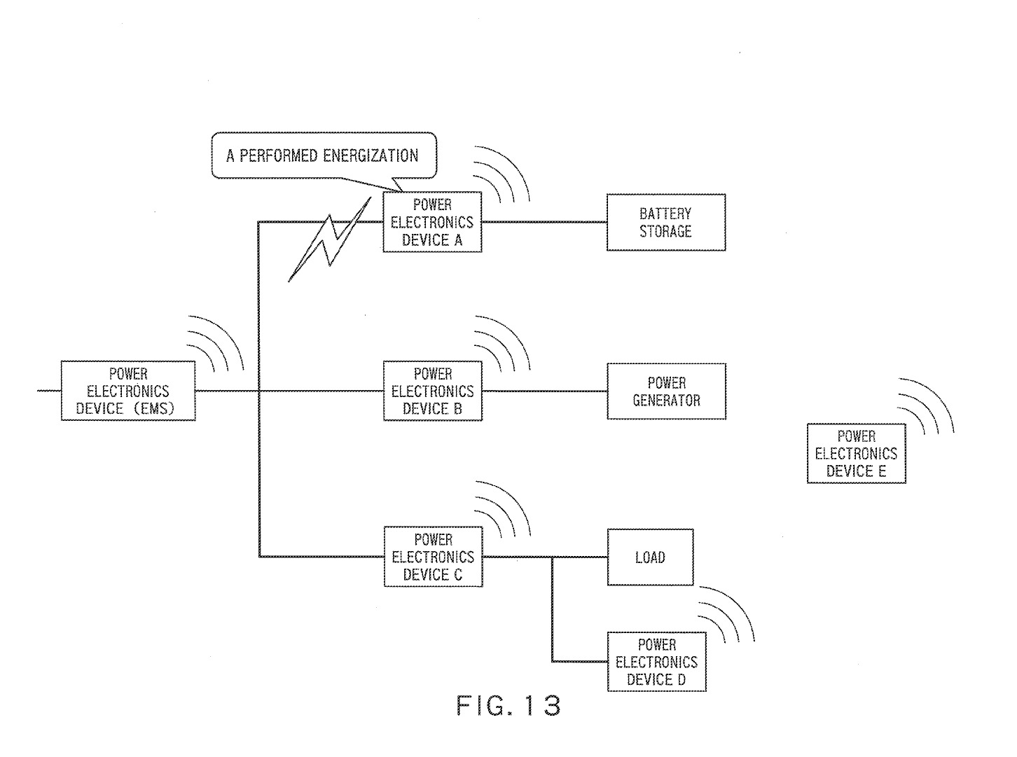

In method 4, a power electronics device performs energization of an inspection signal, and, after that, the power electronics device having performed the energization notifies the execution of the energization to peripheral power electronics devices. That is, as illustrated in FIG. 22(A), a power electronics device performs energization of an Inspection signal for a power line, and, after that, the device having performed the energization of an inspection signal transmits a notification Including device identification Information. In the example illustrated in FIG. 13, power electronics device A performs energization and notifies the execution of the energization to the surroundings thereafter.

A power electronics device having detected the inspection signal and received the notification can understand that it is connected to the power electronics device of the notification source through the power line. The power electronics device that newly understands the power connection relationship can report the update of power connection information to peripheral power electronics devices. In the example of FIG. 13, the power electronics device EMS and power electronics devices B, and C correspond to the power electronics device having received both of the energization and the notification.

A power electronics device that has not detected the inspection signal and that has received the notification can understand that it does not have connection with the power electronics device of the notification source through the power line. In the example of FIG. 13, power electronics devices D and E correspond to power electronics device having received only the notification.

Moreover, when the power electronics device having received the notification and the inspection signal replies a signal showing the receipt of the inspection signal by communication, the power electronics device of the inspection signal issue source can also understand the power connection state. Moreover, by monitoring both of the above-mentioned Inspection signal and the reply, other power electronics devices than the above-mentioned two power electronics devices can also understand the power connection relationship. Moreover, by monitoring both of the above-mentioned notification and the reply, other devices having a communication function than the above-mentioned two power electronics devices can also understand that there is the power connection relationship between the above-mentioned two power electronics devices.

### [Method 5]

In the present method, a power electronics device performs energization of an inspection signal, and, after that, a power electronics device having detected the energization advertises the detection of the energization. That is, as illustrated in FIG. 22(B), a power electronics device performs energization of an inspection signal, and, after that, a power electronics device having detected the energization transmits an advertisement including its own device identification information.

The power electronics device having performed the energization of an inspection signal prepares to receive the advertisement from the power electronics device having detected the energization. In a case where the power electronics device having performed the energization receives the advertisement, it understands that it is connected to the power electronics device of the advertisement source through a power line. Moreover, when the power electronics device having received an inspection signal and advertisement about energization detection replies a signal showing the receipt of the inspection signal by communication, the power electronics device of the inspection signal issue source can understand the power connection state. Moreover, by monitoring both of the above-mentioned inspection signal and the reply, other power electronics devices than the above-mentioned two power electronics devices can also understand the power connection relationship. Moreover, by monitoring both of the above-mentioned advertisement and the reply, other devices having a communication function than the above-mentioned two power electronics devices can also understand that there is the power connection relationship between the above-mentioned two power electronics devices. The power electronics device that newly understands the power connection relationship can report the update of power connection information to peripheral power electronics devices.

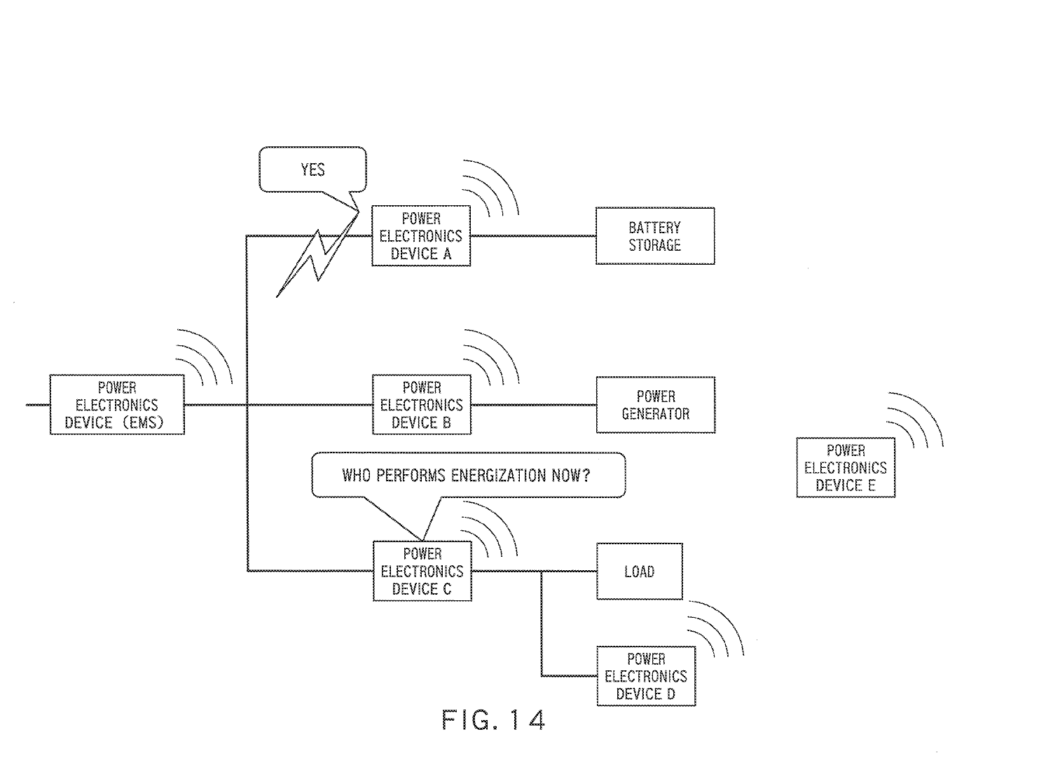

In the example illustrated in FIG. 14, power electronics device A performs energization and prepares to receive an advertisement. Power electronics device C detects the energization and transmits the advertisement including the detection Information. By receiving the advertisement, Power electronics device A can confirm connection with power electronics device C. Although the Illustrated example shows a state where power electronics device C transmits an advertisement, it is considered that the power electronics device (EMS) and power electronics device B take a similar action.

### [Method 6]

In the present method, at the time of normal operation, a power electronics device checks power source information (such as the voltage value and frequency) on a power line advertised from another device and power source Information on a power line connected to the subject apparatus, and understands the power connection relationship with another apparatus. In the present method, examination energization performed in methods 1 to 5 is not unnecessary. For example, as Illustrated in FIG. 22(C), when each power electronics device performs advertisement including its own device identification information and power source Information and receives a similar advertisement from another power electronics device, each power electronics device understands the power connection relationship with another power electronics device. It is not necessary to output an inspection signal to a power line.

A power electronics device advertises power source information on a power line to which the apparatus is connected, to a peripheral power electronics device in a conductive state after the start of operation. The power electronics device having received the advertisement understands whether it is connected to the power electronics device of the advertisement source through a power line, based on whether the advertised power source information matches power source information on the power line to which the device is connected. In a case where they are matched, it determines that it is connected to the power electronics device of the advertisement source. Here, the power electronics device having received the advertisement may be in a conductive state via the power line.

In a case where there are a plurality of power lines with content of the same power source information, although there is a possibility of acquiring a wrong power connection relationship, the present method is effective when it is possible to deny such a possibility. Since the present method is an applicable method even after the start of operation (at the time of normal driving), even in a case where the configuration of power wiring is changed after the start of operation, it is possible to acquire the changed configuration without stopping the operation.

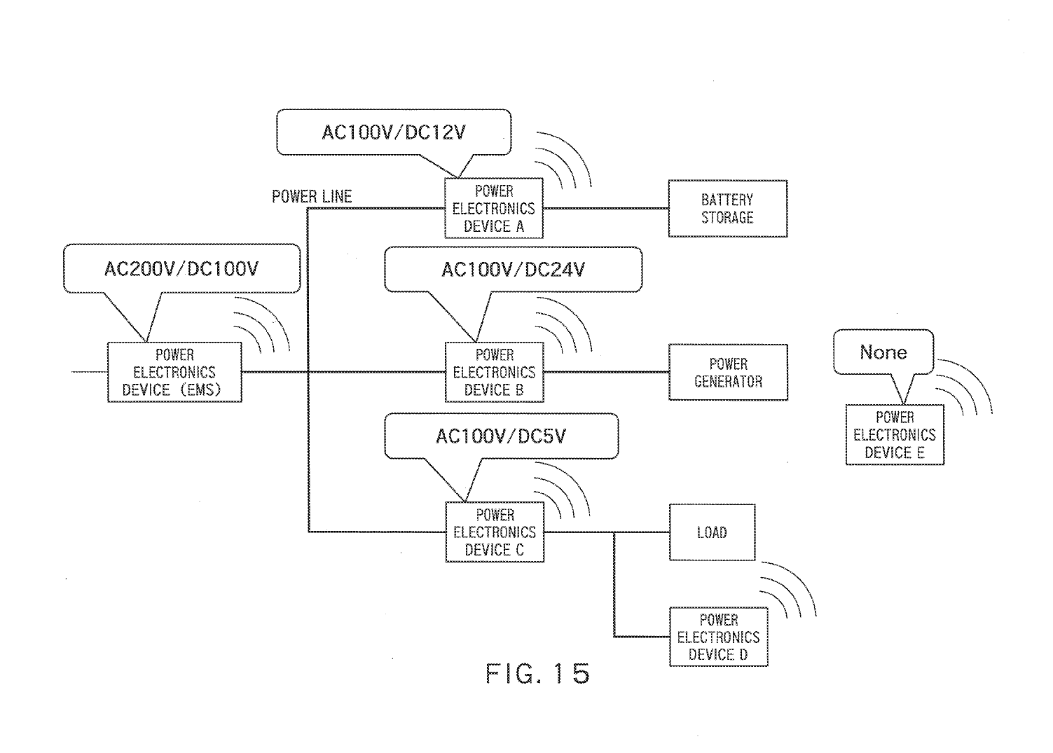

A specific example of the present method is shown. As shown in FIG. 15, power electronics device A advertises power source information (such as AC 100 V) of the first connection unit and power source information (such as DC 12 V) of the second connection. Other power electronics devices similarly advertise power source information. An advertisement method is arbitrary. For example, the advertisement may be periodically performed or performed only when a request is received from another power electronics device by communication. Here, power electronics device E is not connected to any power line and therefore does not perform advertisement, or perform advertisement that it is not connected to any power line.

In the illustrated example, by receiving the power source Information from each power electronics device, power electronics device C is assumed to decide that power source information on the first connection unit from power electronics device A, power source information on the second connection unit of the power electronics device (EMS) and power source information on the first connection unit of power electronics device B match power source information on its own first connection unit. At this time, power electronics device C decides that it is connected to the same power line as the first connection unit of power electronics device A, the second connection unit of the power electronics device (EMS) and the first connection unit of power electronics device B.

Here, there is a case where a device to be connected is fixed in some of power lines such as a power line that connects an inverter and a battery storage in one-to-one correspondence. When power source information on such a power line includes that the connection is fixed, it is possible to distinguish power wiring states even if there are a plurality of power lines with the same voltage value or frequency. Such fixing information may be set in advance by, for example, manager's manual input in a power electronics device.

Communication using each method described above does not matter whether it is wire communication or it is wireless communication. It is not excluded to use power line communication as wire communication. In the case of using other cables than a power line as a communications line, it is possible to avoid a trouble due to noise caused in power line communication.

Although the configuration of the power electronics device described above includes both an electricity change unit and an electricity detection unit, a configuration is possible in which one of the electricity change unit and the electricity detection unit is removed.

As an example, in a case where method 1 described in FIG. 10 is adopted, a power electronics device that receives notification (such as power electronics device C) can acquire the power wiring relationship with a power electronics device of the notification source (such as power electronics device B) without using the electricity change unit. Moreover, by acquiring updated power connection information from the power electronics device of the notification destination by communication, the power electronics device of the notification source can understand the connection topology with the notification destination without using the electricity detection unit.

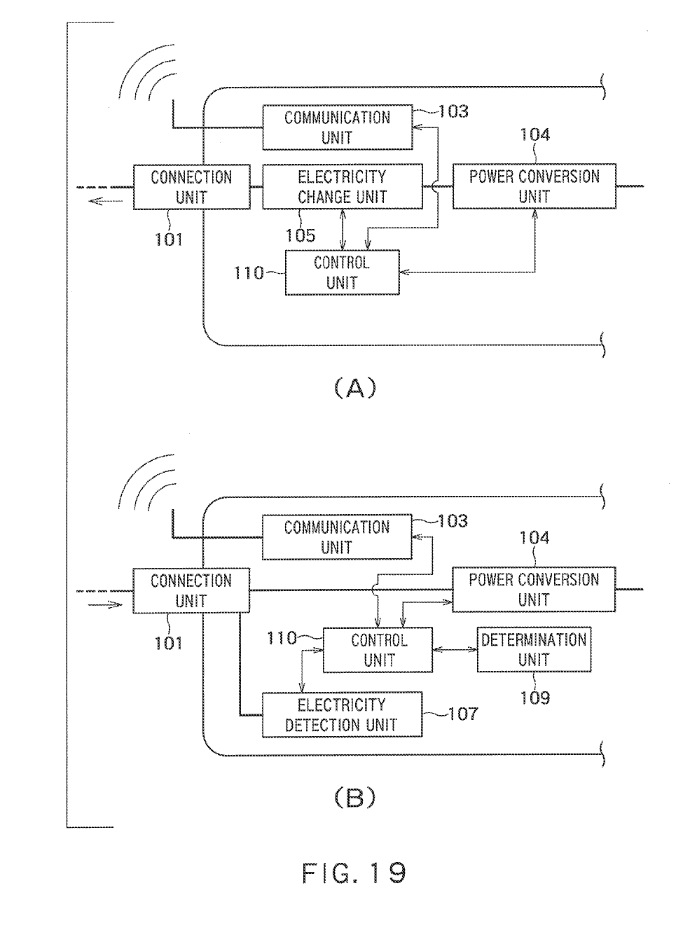

In this case, the power electronics device of the notification source may have a configuration without the electricity detection unit and the determination unit, as illustrated in FIG. 19(A). The second electricity detection unit 108 (see FIG. 18) on the side of the second connection unit 102 may be similarly removed. Moreover, the power electronics device of the notification destination may be configured without the electricity change unit as Illustrated in FIG. 19(B). The second electricity change unit 106 (see FIG. 18) on the side of the second connection unit 102 may be similarly removed.

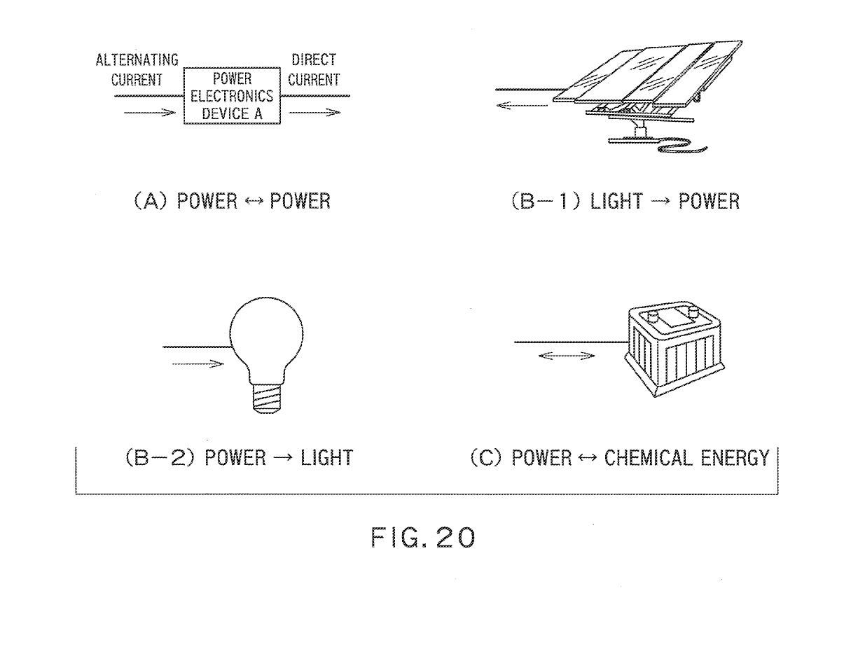

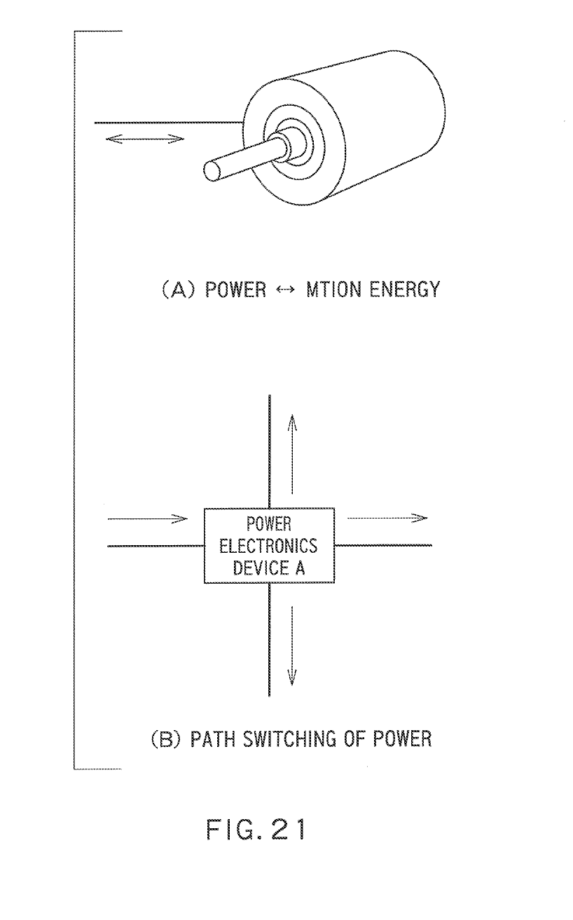

Although the power electronics device described above performs conversion (AC/AC, AC/DC, DC/DC) between powers as Illustrated in FIG. 20(A), the power electronics device of the present embodiment is not limited to the one that performs conversion between powers. For example, the one that converts light into power (for example, a solar photovoltaic device) is possible as illustrated in FIG. 20(B-1). Moreover, the one that converts power into light (for example, illumination) is possible as Illustrated in FIG. 20(B-2). Moreover, the one that converts power into chemical energy or chemical energy into power (for example, a battery storage) is possible as illustrated in FIG. 20(C). Moreover, the one that converts power into motion energy or performs conversion opposite thereto (such as a motor and a power generator) is possible as illustrated in FIG. 21(A). Moreover, a power router that converts (switches) a path of power is possible as illustrated in FIG. 21(B). Moreover, a power source measurement device that measures the voltage or current is possible.

In the case of the devices or power source measurement devices as illustrated in FIG. 20(B-1), FIG. 20(B-2), FIG. 20(C) and FIG. 21(A), a configuration is possible in which the second electricity change unit 106, the second connection terminal 102 and the second electricity detection unit 108 of the configuration Illustrated in FIG. 18 are removed. Even in the case of the configurations illustrated FIG. 19(A) and FIG. 19(B), a configuration is possible in which these components are similarly removed.

As described above, according to the present embodiment, in a case where a plurality of power electronics devices performs control in collaboration with each other, it is possible activate power electronics devices while correctly understanding the power connection relationships even if the configuration of power wiring is changed. Therefore, while the flexibility of installation locations is maintained, at the time of expansion or maintenance, it is possible to automatically increase the capacity and maintain the total amount of charge/discharge power throughputs of distributed power sources.

Moreover, according to the present embodiment, since it is possible to automatically acquire the power connection relationship if the configuration of power wiring is changed, the worker is not required for the input of power connection information and the reduction in the engineering cost is realized.

Moreover, according to the present embodiment, the power wiring topology of a plurality of power electronics devices is not limited, and combinations with high flexibility are possible at the time of simultaneous operation of these. Moreover, since it is possible to cope with the change in the wiring topology after the start of operation, wide application which is impossible in power electronics devices in the related art is possible.

The power electronics devices which have been heretofore described may also be realized using a general-purpose computer device as basic hardware. That is, the power electronics devices can be realized by causing a processor mounted in the above described computer device to execute a program. In this case, the power electronics device may be realized by installing the above described program in the computer device beforehand or may be realized by storing the program in a storage medium such as a CD-ROM or distributing the above described program over a network and Installing this program in the computer device as appropriate. Furthermore, the storage in the power electronics device may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power electronics device comprising:
a connection unit connected to a first power line;
a communication unit performing communication with other power electronics devices;
at least one unit of an electricity change unit changing an energization state of the first power line and an electricity detection unit detecting a change in the energization state of the first power line; and
a control unit specifying a power electronics device connected to the first power line out of the other power electronics devices using the communication unit and said at least one unit of the electricity change unit and the electricity detection unit.

2. The power electronics device according to claim 1, wherein the communication unit performs communication with the other power electronics devices using a communication medium different from the first power line.

3. The power electronics device according to claim 1, wherein:
the electricity change unit changes the first power line from non-conductive state to a conductive state or changes a characteristic of an electrical signal in the first power line, as the change in the energization state; and
the electricity detection unit detects the change in the first power line from the non-conductive state to the conductive state or the change in the characteristic of the electrical signal in the first power line, as the change in the energization state.

4. The power electronics device according to claim 1, wherein:
the communication unit receives a notice from a first power electronics device that is one of the other power electronics devices that a energization state of a power line connected to the first power electronics device is to be changed, or performs communication to build a consensus with the first power electronics device that the energization state of the power line is to be changed by the first power electronics device; and
the control unit decides whether the first power electronics device is connected to the first power line, depending on whether the electricity detection unit detects the change in the energization state of the first power line after the communication unit receives the notice or builds the consensus.

5. The power electronics device according to claim 1, wherein:
the communication unit transmits a request to a first power electronics device that is one of the other power electronics devices so as to change an energization state of a power line connected to the first power electronics device; and
the control unit decides whether the first power electronics device is connected to the first power line, depending on whether the electricity detection unit detects the change in the energization state of the first power line after the communication unit transmits the request.

6. The power electronics device according to claim 1, wherein:
the communication unit transmits a notification to the other power electronics devices that the energization state of the first power line is to be changed;
the electricity change unit changes the energization state of the first power line concurrently with or after the transmission of the notification by the communication unit; and
the control unit decides that a first power electronics device that is one of the other power electronics devices is connected to the first power line in a case where detection of the change in the energization state is reported from the first power electronics device.

7. The power electronics device according to claim 1, wherein:
the electricity detection unit detects the change in the energization state of the first power line; and
the control unit decides that a first power electronics device that is one of the other power electronics devices is connected to the first power line in a case where the communication unit receives a notification of having changed the energization state from the first power electronics device after the electricity detection unit detects the change in the energization state.

8. The power electronics device according to claim 1, wherein:
the electricity change unit changes the energization state of the first power line;
the communication unit transmits a notification of having changed the energization state to the other power electronics devices after the electricity change unit changes the energization state; and
the control unit decides that a first power electronics device that is one of the other power electronics devices is connected to the first power line in a case where detection of the change in the energization state is reported from the first power electronics device.

9. The power electronics device according to claim 1, wherein, when it is decided that a first power electronics device that is one of the other power electronics devices is connected to the first power line, the communication unit transmits power connection information that the first power electronics device is connected to the first power line, to at least one of the other power electronics devices.

10. A power electronics device comprising:
a connection unit connected to a first power line;
a communication unit performing communication with other power electronics devices; and
a control unit, wherein:
the communication unit receives power source information on power lines connected to the other power electronics devices, from the other power electronics devices; and
the control unit decides whether the other power electronics devices each are connected to the first power line, based on the power source information received from the other power electronics devices and power source information on the first power line.

11. The power electronics device according to claim 10, wherein the communication unit performs communication with the other power electronics devices using a communication medium different from the first power line.

12. A power connection inspection method performed in a power electronics device connected to a first power line, comprising:
performing communication with other power electronics devices;
performing at least one of changing an energization state of the first power line and detecting a change in the energization state of the first power line; and
specifying a power electronics device connected to the first power line out of the other power electronics devices based on the communication and said at least one of changing the energization state and detecting the change in the energization state.

13. The method according to claim 12, wherein the communication is performed using a communication medium different from the first power line.

14. A non-transitory computer readable medium including instructions stored therein, which cause, when executed by a processor in a power electronics device connected to a first power line, to execute steps comprising:
performing communication with other power electronics devices;
performing at least one of changing an energization state of the first power line and detecting a change in the energization state of the first power line; and
specifying a power electronics device connected to the first power line out of the other power electronics devices based on the communication and said at least one of changing the energization state and detecting the change in the energization state.

15. The medium according to claim 14, wherein the communication is performed using a communication medium different from the first power line.
